(19) United States
(12) Patent Application Publication
(10) Pub. No.: US 2022/0236912 A1
(43) Pub. Date: Jul. 28, 2022

(54) FIRMWARE PARAMETERS AUTO-TUNING FOR MEMORY SYSTEMS

(71) Applicant: SK hynix Inc., Gyeonggi-do (KR)

(72) Inventors: Dmitri ZELENIAK, Minsk (BY); Uladzimir MARCHANKA, Minsk (BY); Uladzimir HREK, Minsk (BY)

(21) Appl. No.: 17/160,040

(22) Filed: Jan. 27, 2021

(51) Int. Cl. G06F 3/06

(52) U.S. Cl. CPC G06F 3/0659; G06F 3/0679; G06F 3/0604; G06F 3/0653

(57) ABSTRACT

A controller of a memory system automatically tunes parameters of firmware (FW). The controller includes firmware and a performance optimizer. The performance optimizer is configured to: compute one or more performance and power metrics based on commands received from the host; select a parameter set among multiple parameter sets for the firmware based on the one or more performance and power metrics; and provide the selected parameter set to use in one or more flash translation layers.

### BACKGROUND

### 1. Field

Embodiments of the present disclosure relate to a scheme for tuning firmware parameters in a memory system.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices.

Memory systems using memory devices provide excellent stability, durability, high information access speed, and low power consumption, since they have no moving parts. Examples of memory systems having such advantages include universal serial bus (USB) memory devices, memory cards having various interfaces such as a universal flash storage (UFS), and solid state drives (SSDs). Memory systems may include various components such firmware (FW) and hardware (HW) components. Firmware contains parameters that effect operating conditions. In this context, embodiments of the invention arise.

### SUMMARY

Aspects of the present invention include a system and a method for automatically tuning firmware parameters.

In one aspect, a data processing system includes a host and a memory system coupled to the host, the memory system including a memory device and a controller for controlling the memory device. The controller includes firmware and a performance optimizer configured to: compute one or more performance and power metrics based on commands received from the host; select a parameter set among multiple parameter sets for the firmware based on the one or more performance and power metrics; and provide the selected parameter set to use in one or more flash translation layers.

In another aspect, a data processing system includes a host and a memory system coupled to the host, and the memory system including a memory device and a controller for controlling the memory device. The controller includes: firmware; a workload detector configured to measure workload characteristics associated with commands received from the host; and a performance optimizer configured to: compute one or more performance and power metrics based on the measuring of the workload characteristics; select a parameter set among multiple parameter sets for the firmware based on the one or more performance and power metrics; and provide the selected parameter set to use in one or more flash translation layers.

Additional aspects of the present invention will become apparent from the following description.

### BRIEF DESCRIPTION OF THE DRAWINGS

FIG. 1 is a block diagram illustrating a data processing system in accordance with an embodiment of the present invention.

FIG. 2 is a block diagram illustrating a memory system in accordance with an embodiment of the present invention.

FIG. 3 is a circuit diagram illustrating a memory block of a memory device in accordance with an embodiment of the present invention.

FIG. 4 is a diagram illustrating a data processing system in accordance with an embodiment of the present invention.

FIG. 5 is a diagram illustrating a solid state drive (SSD) in accordance with an embodiment of the present invention.

FIG. 6 is a diagram illustrating a performance optimizer in accordance with an embodiment of the present invention.

FIG. 7 is a flowchart illustrating a firmware parameter tuning scheme in accordance with an embodiment of the present invention.

FIG. 8 is a sequence diagram illustrating a firmware parameter tuning scheme in accordance with an embodiment of the present invention.

FIG. 9 is a diagram illustrating a solid state drive (SSD) in accordance with an embodiment of the present invention.

FIG. 10 is a diagram illustrating a performance optimizer in accordance with an embodiment of the present invention.

FIG. 11 is a flowchart illustrating a firmware parameter tuning scheme in accordance with an embodiment of the present invention.

FIG. 12 is a sequence diagram illustrating a firmware parameter tuning scheme in accordance with an embodiment of the present invention.

FIG. 13 illustrates an example of building a workload characteristics-to-suboptimal parameters (W2P) table in accordance with an embodiment of the present invention.

### DETAILED DESCRIPTION

Various embodiments are described below in more detail with reference to the accompanying drawings. The present invention may, however, be embodied in different forms and thus should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrase are not necessarily to the same embodiment(s). Throughout the disclosure, like reference numerals refer to like parts in the figures and embodiments of the present invention.

The invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims. The invention encompasses numerous alternatives, modifications and equivalents within the scope of the claims. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

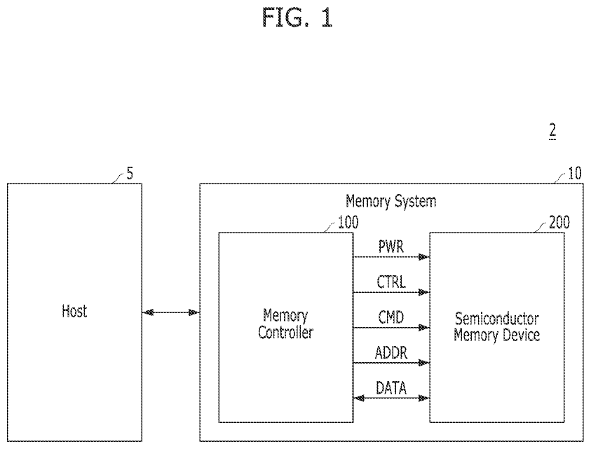

FIG. 1 is a block diagram illustrating a data processing system 2 in accordance with an embodiment of the present invention.

Referring FIG. 1, the data processing system 2 may include a host device 5 and a memory system 10. The memory system 10 may receive a request from the host device 5 and operate in response to the received request. For example, the memory system 10 may store data to be accessed by the host device 5.

The host device 5 may be implemented with any of various types of electronic devices. In various embodiments, the host device 5 may include an electronic device such as a desktop computer, a workstation, a three-dimensional (3D) television, a smart television, a digital audio recorder, a digital audio player, a digital picture recorder, a digital picture player, and/or a digital video recorder and a digital video player. In various embodiments, the host device 5 may include a portable electronic device such as a mobile phone, a smart phone, an e-book, an MP3 player, a portable multimedia player (PMP), and/or a portable game player.

The memory system 10 may be implemented with any of various types of storage devices such as a solid state drive (SSD) and a memory card. In various embodiments, the memory system 10 may be provided as one of various components in an electronic device such as a computer, an ultra-mobile personal computer (PC) (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

The memory system 10 may include a memory controller 100 and a semiconductor memory device 200. The memory controller 100 may control overall operation of the semiconductor memory device 200.

The semiconductor memory device 200 may perform one or more erase, program, and read operations under the control of the memory controller 100. The semiconductor memory device 200 may receive a command CMD, an address ADDR and data DATA through input/output lines. The semiconductor memory device 200 may receive power PWR through a power line and a control signal CTRL through a control line. The control signal CTRL may include a command latch enable signal, an address latch enable signal, a chip enable signal, a write enable signal, a read enable signal, as well as other operational signals depending on design and configuration of the memory system 10.

The memory controller 100 and the semiconductor memory device 200 may be integrated in a single semiconductor device such as a solid state drive (SSD). The SSD may include a storage device for storing data therein. When the semiconductor memory system 10 is used in an SSD, operation speed of a host device (e.g., host device 5 of FIG. 1) coupled to the memory system 10 may remarkably improve.

The memory controller 100 and the semiconductor memory device 200 may be integrated in a single semiconductor device such as a memory card. For example, the memory controller 100 and the semiconductor memory device 200 may be so integrated to configure a personal computer (PC) card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

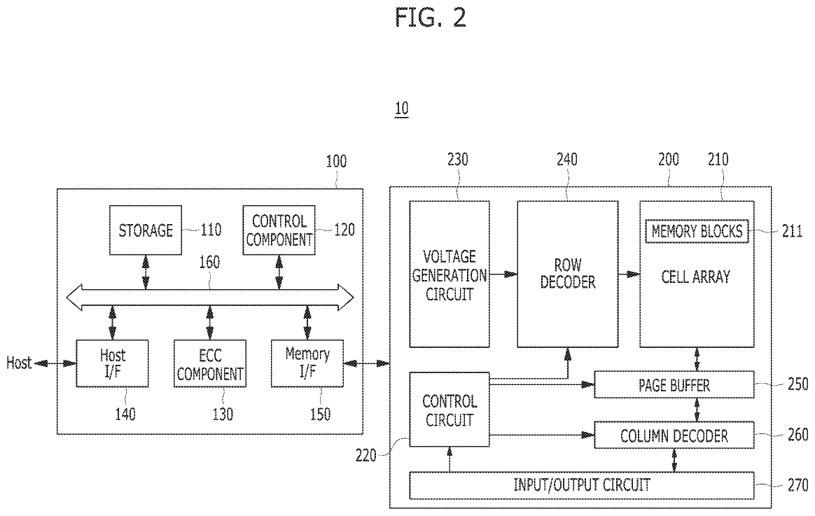

FIG. 2 is a block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device (e.g., host device 5 of FIG. 1), and in particular, store data to be accessed by the host device.

The memory device 200 may store data to be accessed by the host device.

The memory device 200 may be implemented with a volatile memory device such as a dynamic random access memory (DRAM) and/or a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as a central processing unit (CPU), an error correction code (ECC) component 130, a host interface (I/F) 140 and a memory interface (I/F) 150, which are coupled through a bus 160.

The storage 110 may serve as a working memory of the memory system 10 and the controller 100, and store data for driving the memory system 10 and the controller 100. When the controller 100 controls operations of the memory device 200, the storage 110 may store data used by the controller 100 and the memory device 200 for such operations as read, write, program and erase operations.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 may control general operation of the memory system 10, and in particular a write operation and a read operation for the memory device 200 in response to a corresponding request from the host device. The control component 120 may drive firmware, which is referred to as a flash translation layer (FTL), to control general operations of the memory system 10. For example, the FTL may perform operations such as logical-to-physical (L2P) mapping, wear leveling, garbage collection, and/or bad block handling. The L2P mapping is known as logical block addressing (LBA).

The ECC component 130 may detect and correct errors in the data read from the memory device 200 during the read operation. The ECC component 130 may not correct error bits when the number of the error bits is greater than or equal to a threshold number of correctable error bits, and instead may output an error correction fail signal indicating failure in correcting the error bits.

In various embodiments, the ECC component 130 may perform an error correction operation based on a coded modulation such as a low density parity check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM). However, error correction is not limited to these techniques. As such, the ECC component 130 may include any and all circuits, systems or devices for suitable error correction operation.

The host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and/or an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the control component 120. When the memory device 200 is a flash memory such as a NAND flash memory, the memory interface 150 may generate control signals for the memory and process data under the control of the control component 120.

The memory device 200 may include a memory cell array 210, a control circuit 220, a voltage generation circuit 230, a row decoder 240, a page buffer 250 which may be in the form of an array of page buffers, a column decoder 260, and an input and output (input/output) circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform a program, read, or erase operation on the memory cell array 210. The control circuit 220 may control the peripheral circuit.

The voltage generation circuit 230 may generate operation voltages of various levels. For example, in an erase operation, the voltage generation circuit 230 may generate operation voltages of various levels such as an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address generated by the control circuit 220, and transmit operation voltages supplied from the voltage generation circuit 230 to the selected memory blocks.

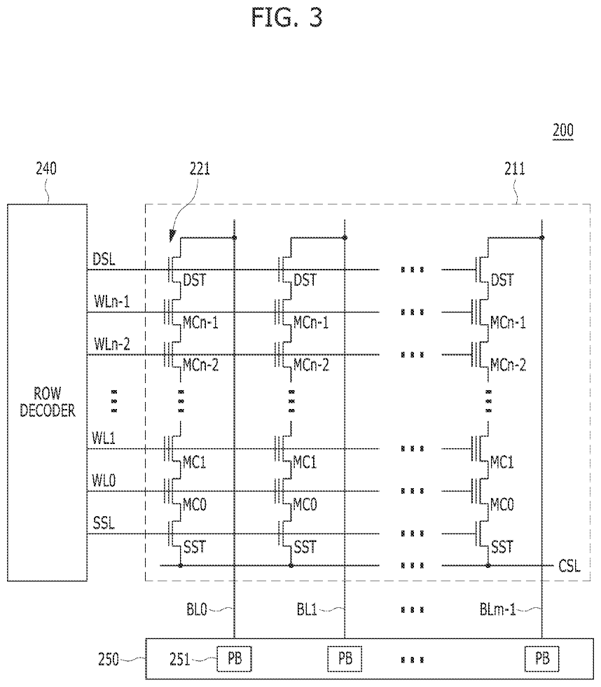

The page buffer 250 may be coupled with the memory cell array 210 through bit lines BL (shown in FIG. 3). The page buffer 250 may precharge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250 or transmit and receive data to and from the input/output circuit 270.

The input/output circuit 270 may transmit to the control circuit 220 a command and an address, received from an external device (e.g., the memory controller 100 of FIG. 1), transmit data from the external device to the column decoder 260, or output data from the column decoder 260 to the external device, through the input/output circuit 270.

The control circuit 220 may control the peripheral circuit in response to the command and the address.

FIG. 3 is a circuit diagram illustrating a memory block of a semiconductor memory device in accordance with an embodiment of the present invention. For example, the memory block of FIG. 3 may be any of the memory blocks 211 of the memory cell array 210 shown in FIG. 2.

Referring to FIG. 3, the memory block 211 may include a plurality of word lines WL0 to WLn−1, a drain select line DSL and a source select line SSL coupled to the row decoder 240. These lines may be arranged in parallel, with the plurality of word lines between the DSL and SSL.

The memory block 211 may further include a plurality of cell strings 221 respectively coupled to bit lines BL0 to BLm−1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn−1 may be serially coupled between the selection transistors DST and SST. Each of the memory cells may be formed as a single level cell (SLC) storing 1 bit of data, a multi-level cell (MLC) storing 2 bits of data, a triple-level cell (TLC) storing 3 bits of data, or a quadruple-level cell (QLC) storing 4 bits of data.

The source of the SST in each cell string may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array 250 may include a plurality of page buffers 251 that are coupled to the bit lines BL0 to BLm−1. The page buffers 251 may operate in response to page buffer control signals. For example, the page buffers 251 may temporarily store data received through the bit lines BL0 to BLm−1 or sense voltages or currents of the bit lines during a read or verify operation.

In some embodiments, the memory blocks 211 may include NAND-type flash memory cells. However, the memory blocks 211 are not limited to such cell type, but may include NOR-type flash memory cells. Memory cell array 210 may be implemented as a hybrid flash memory in which two or more types of memory cells are combined, or one-NAND flash memory in which a controller is embedded inside a memory chip.

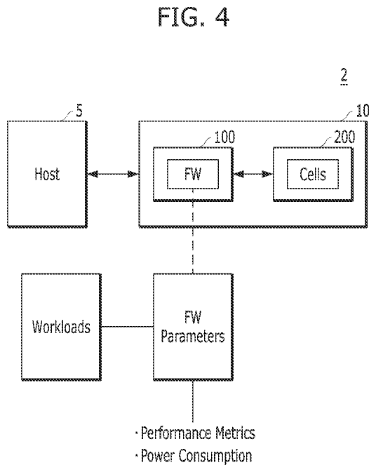

FIG. 4 is a diagram illustrating a data processing system 2 in accordance with an embodiment of the present invention.

Referring to FIG. 4, the data processing system 2 may include a host 5 and a memory system 10. The memory system 10 may include a controller 100 and a memory device 200. The controller 100 may include firmware (FW) as a specific class of software for controlling various operations (e.g., read, write, and erase operations) for the memory device 200. In some embodiments, the firmware may reside in the storage 110 and may be executed by the control component 120, in FIG. 2.

The memory device 200 may include a plurality of memory cells (e.g., NAND flash memory cells). The memory cells are arranged in an array of rows and columns as shown in FIG. 3. The cells in a particular row are connected to a word line (e.g., WL0), while the cells in a particular column are coupled to a bit line (e.g., BL0). These word and bit lines are used for read and write operations. During a write operation, the data to be written (‘1’ or ‘0’) is provided at the bit line while the word line is asserted. During a read operation, the word line is again asserted, and the threshold voltage of each cell can then be acquired from the bit line. Multiple pages may share the memory cells that belong to (i.e., are coupled to) the same word line.

In the memory system 10 such as a solid state drive (SSD), performance metrics such as throughput, latency, and consistency are important. Customers may require throughput and consistency greater than certain minimal levels. The requirements for latency contain maximum values in terms of percentiles up to 99.999999% (also referred to as eight nines or 8th nine level). Different requirements are given for different specific workloads of interest to customers. At the same time, usually, there are also restrictions on the average and peak power consumption of SSD, which obviously impact the possible achievable performance.

Integrated circuits manufacturing technology, architectures of NAND and system on a chip (SoC), and frequencies and timings of hardware (HW) components, such as a controller and a memory (e.g., a dynamic random access memory (DRAM)) significantly affect the performance of the memory system 10. Also, firmware (FW) algorithms use many parameters which should be tuned in an optimal way from a performance point of view. Unlike HW characteristics, FW parameters may be tuned on the fly. In particular, processors frequencies may be changed programmatically in FW. In order to improve one performance metric (e.g., read latency), some FW parameters should be changed. However, changing FW parameters to improve one performance metric may affect performance of another metric (e.g., write latency). For example, changes in FW parameters may improve latencies for some nines and worsen latencies for others. Moreover, there may be analogical contradictions with regard to FW parameters for different workloads. For example, good parameters for one type of workload may be bad for other types of workloads. These contradictions complicate the selection of the optimal FW parameters, especially with additional restrictions on power consumption.

Selection of optimal FW parameters is a poorly formalized process based on trial and error and is one of the most resource-consuming and time-consuming operations. Moreover, parameters are selected for only predefined standard test workloads during the FW development stage. That means any difference in real workload from the test will cause not optimal drive behavior. Accordingly, it is desirable to provide a scheme to automatically tune or adjust FW parameters for performance and power consumption enhancement of a memory system (e.g., SSD).

In accordance with embodiments, the controller 100 of FIG. 4 may provide schemes of FW parameters auto-tuning based on the measurement of performance metrics and power consumption in real time and adjustment parameters to changing workloads by a feedback loop on the fly. Embodiments may allow tuning of device parameters as well as parameters of different flash translation layer (FTL) algorithms, such as garbage collector, program and erase suspending, wear leveling, refreshing and write throttling in order to achieve the best performance under power consumption limitations for a given workload. Embodiments may improve customers' performance metrics of SSD under restrictions on power consumption.

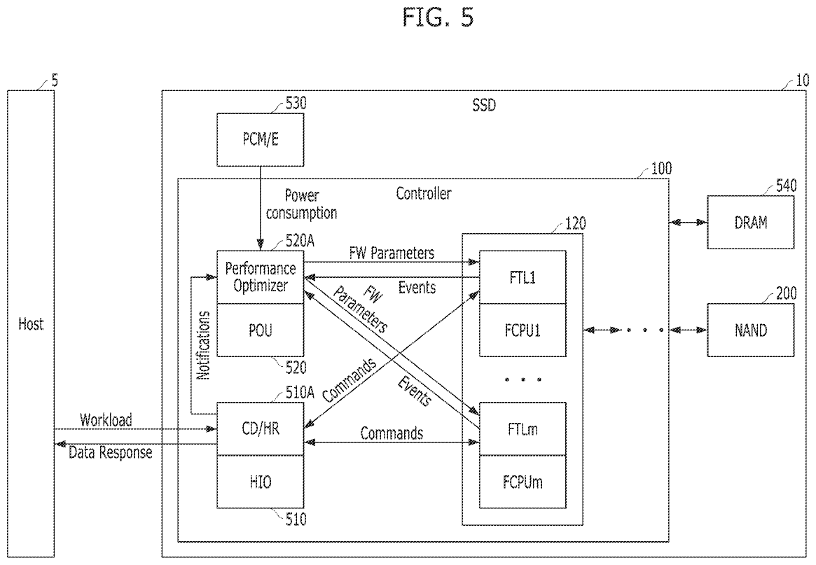

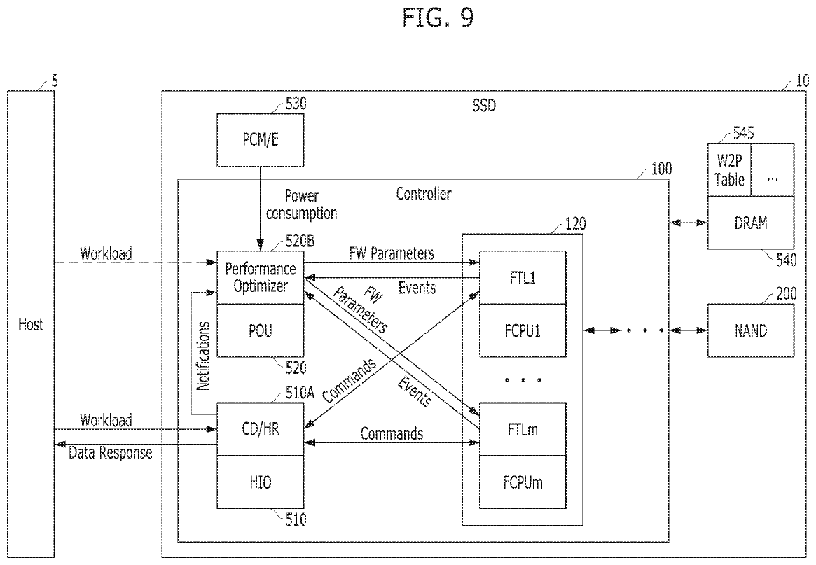

The controller 100 may provide schemes for FW parameters tuning as a response to workload changes, which may be implemented in FW, such as scheme A and scheme B. In accordance with scheme A, parameters are selected in the feedback process where the needed performance and power metrics are computed during the work of the memory system and parameters are adjusted based on these metrics. Operations of scheme A are described below with reference to FIGS. 5 to 8. In accordance with scheme B, parameters are sought for new workloads as in scheme A and besides, workload characteristics are detected and the correspondence table is created during the feedback process to reuse early found parameters. Operations of scheme B are described below with reference to FIGS. 9 to 12.

For both schemes, a search algorithm of suboptimal (further it means local optimality) FW parameters may be used to improve performance metrics by parameters selection. One implementation of suboptimal search algorithm is described in U.S. patent application Ser. No. 17/063,349, entitled “FIRMWARE PARAMETERS OPTIMIZING SYSTEMS AND METHODS” which is incorporated by reference herein in its entirety.

In accordance with embodiments, customers' performance metrics may be calculated and optimized on the fly in a memory system (e.g., a solid state drive (SSD)). The performance metrics may include throughput or input/output operations per second (IOPS); average read and write latencies; percentiles of read and write latencies on some 9's levels; consistency (i.e., a ratio of a certain percentile of IOPS distribution and the average IOPS); standard and maximum deviations of throughput and latencies.

All metrics above, except, perhaps, percentiles, may be calculated relatively fast in the drive itself. The real rate depends on the current performance for a given workload. The percentile of i-th level of nines requires 10 times more host commands and, consequently, computing time than (i−1)-th. Therefore, low 9's are more realistic to calculate quickly and use for optimization by the proposed approach.

Based on the customers' preferences, an objective function may be constructed, which includes the listed above metrics with some weights reflecting the metrics' importance. Therefore, the FW parameters search algorithm should optimize the objective function as an implicit function of FW parameters with possible additional restrictions on the allowable values of some performance and power metrics. The mentioned metrics weights and restrictions values may be transmitted from the host by means of a vendor unique command or with the workload by a set protocol (e.g., the NVMe protocol).

FW parameters may affect power consumption in a memory system (e.g., a solid state drive (SSD)) because they can determine the number of the needed internal service operations, synchronization of commands execution by dies, the intensity of using buffers, etc. In some embodiments, power metrics may be calculated and used as restrictions for optimization of FW parameters: average power consumption; maximal power consumption.

Hereinafter, schemes of FW parameters auto-tuning based on the measurement of performance metrics and power consumption in real time and adjustment parameters to changing workloads by a feedback loop on the fly are described. It is supposed that the workload is quite stable in time (i.e., rarely changing) during the search algorithm work.

A scheme A of firmware (FW) parameters tuning is described with reference to FIGS. 5 to 8.

FIG. 5 is a diagram illustrating a solid state drive (SSD) 10 in accordance with an embodiment of the present invention.

Referring to FIG. 5, the SSD 10 may be coupled to a host 5. The SSD 10 may include a controller 100 and a memory device (e.g., a NAND flash memory device) 200 coupled to the controller 100. Further, the SSD 10 may include a power consumption meter or estimator (PCM/E) (hereinafter referred to as a power consumption meter) 530 and a dynamic random access memory (DRAM) 540, which are coupled to the controller 100. Although it is illustrated that the DRAM 540 is located at the outside of the controller 100, the DRAM 540 may be located at the inside of the controller 100, as the storage 110 shown in FIG. 2. In the illustrated example, the power consumption meter 530 may be included in the SSD 10. The power consumption meter 530 may be implemented with a power metering unit, which is described in U.S. Patent Application Publication No. US 2019/0272012 A1, entitled “METHOD AND APPARATUS FOR PERFORMING POWER ANALYTICS OF A STORAGE SYSTEM” which is incorporated by reference herein in its entirety. Alternatively, in the case of the absence of a power meter on the board of SSD, power consumption may be approximately calculated using statistics on the numbers and types of commands processed in the memory device (i.e., NAND flash memory device 200) on subintervals of a set time window of short-time intervals T1.

The controller 100 may include a control component 120, a host input and output (HIO) component 510 and a performance optimizer unit (POU) 520. In some embodiments, the control component 120 may include a plurality of flash translation layers (FTLs) and a plurality of FTL flash central processor units (FCPUs) (e.g., m FTLs and m FCPUs).

The HIO component 510 may include elements 510A such as a command dispatcher (CD) and a host responder (HR). The command dispatcher may receive workloads (or commands) from the host 5. The host responder may respond back to the host 5 with the completed commands. For example, the HIO component 510 may correspond to the host interface 140 as shown in FIG. 2.

The host 5 may be provided in a connected arrangement to firmware (FW), which may be executed on the controller 100. The controller 100 may be connected to the NAND flash memory device 200. Commands (or workloads) may be obtained from the host 5 and sent to the command dispatcher. The host responder may respond back to the host 5 with the completed commands.

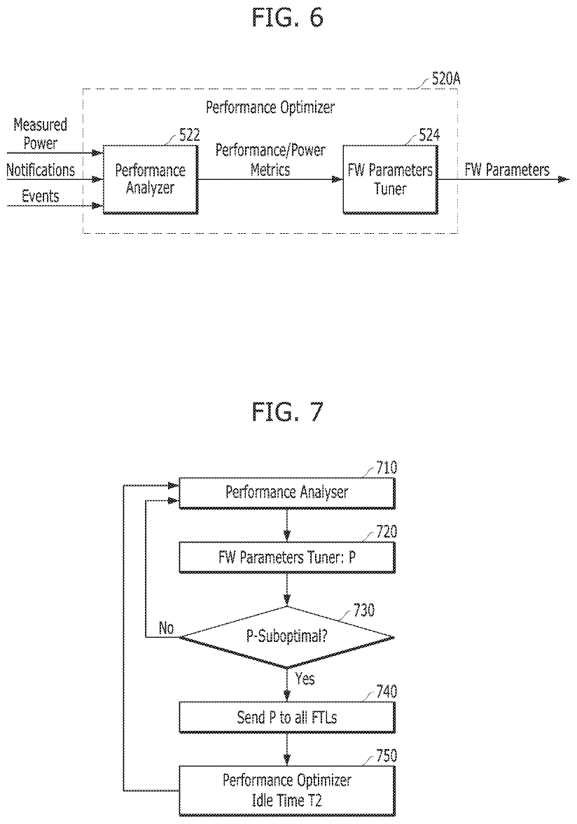

The performance optimizer unit 520 may include a performance optimizer 520A. In some embodiments, the performance optimizer 520A may be implemented as a FW or HW module and its logic may be executed by the performance optimizer unit 520, which may be implemented with some processors. The performance optimizer unit 520 may be located before the FTL flash central processor units (FCPUs) of the control component 120. In other embodiments, HIO or other existing units, or a separate new unit may serve as the performance optimizer unit 520. The performance optimizer 520A may be connected to all FTLs, which are executed in different FCPUs of the control component 120. The performance optimizer 520A may provide calculated FW parameters to all of FTLs by a set protocol (e.g., the inter-process communication (IPC) protocol). The performance optimizer 520A may include a performance analyzer 522 and a firmware (FW) parameters tuner 524, as shown in FIG. 6.

The performance analyzer 522 may receive information such as measured power of the SSD 10, notifications about commands and events associated with executions of the commands, which are associated with workload characteristics. In some embodiments, the measured power may be received from the power consumption meter 530, the notifications may be received from the CD/HR 510A and the events may be received from FTLs. The performance analyzer 522 may analyze the received information and compute one or more performance metrics and/or power metrics using a combination of the analyzed information.

The firmware (FW) parameters tuner 524 may receive one or more performance metrics and/or power metrics from the performance analyzer 522. The FW parameters tuner 524 may select a parameter set (i.e., FW parameters) among multiple FW parameter sets based on the one or more performance and power metrics. The FW parameters tuner 524 may provide the selected FW parameters to one or more FTLs.

For a set time window of short-time intervals T1 (e.g., T1<=1 second), the performance analyzer 522 may store the necessary statistics on the host command latencies, IOPS, power consumption and internal events, such as changes of different FW counters which reflect a current internal state of FW. Further, the performance analyzer 522 may compute the needed performance and/or power metrics on this window using the stored necessary statistics. The performance analyzer 522 may receive notifications about every host command with an indication of the type (read/write), arrival, response times from CD/HR 510A, and events statistics from FTLs. The performance analyzer 522 may also receive the measured or estimated power consumption on subintervals of T1 from the power consumption meter 530.

The FW parameters tuner 524 may realize a selection of parameters set P=(p_1, . . . , p_n) in accordance with a certain search algorithm of suboptimal parameters. As described above, one implementation of suboptimal search algorithm is described in U.S. patent application Ser. No. 17/063,349, entitled “FIRMWARE PARAMETERS OPTIMIZING SYSTEMS AND METHODS” which is incorporated by reference herein in its entirety.

The FW parameters tuner 524 may receive the needed values of the performance and/or power metrics measured on T1, then computes, and sends the changed FW parameters set to all existing FTLs. Therefore, every T1 seconds, FW parameters will slightly change based on the measured performance/power metrics feedback until the suboptimal values of parameters are found. After that, the performance optimizer 520A may be turned off and the SSD 10 works with new parameters during a certain period of time T2 (i.e., idle time for the performance optimizer 520A).

FIG. 7 is a flowchart illustrating a firmware parameter tuning scheme in accordance with an embodiment of the present invention.

Referring to FIG. 7, the firmware parameter tuning scheme may include operations 710 to 750. At operation 710, the performance analyzer 522 may compute one or more performance and power metrics, based on commands received from a host. In some embodiments, the performance analyzer 522 may receive notifications about the commands and events associated with executions of the commands, which are associated with workload characteristics, and measured power consumption of a memory system. Further, the performance analyzer 522 may compute the one or more performance and power metrics based on the received notifications, events and power consumption.

At operation 720, the FW parameters tuner 524 may receive the one or more performance and power metrics from the performance analyzer 522, and select a parameter set (i.e., FW parameters) among multiple parameter sets for the firmware based on the one or more performance and power metrics.

At operation 730, the FW parameters tuner 524 may determine whether the selected FW parameters are suboptimal. When it is determined that the selected FW parameters are suboptimal, at operation 740, the FW parameters tuner 524 may provide the selected FW parameters to use in one or more flash translation layers.

At operation 750, the performance optimizer 520A may be turned off and the SSD 10 works with the selected FW parameters during a certain period of idle time T2.

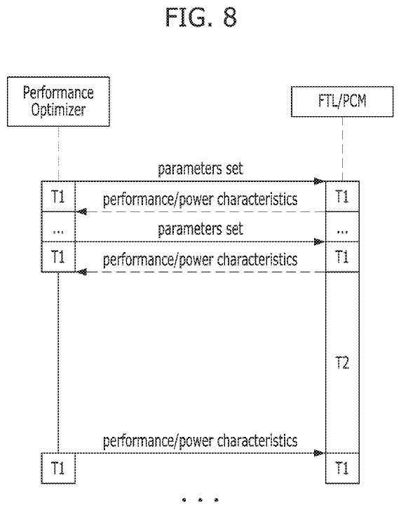

FIG. 8 is a sequence diagram illustrating a firmware parameter tuning scheme in accordance with an embodiment of the present invention.

Referring to FIG. 8, for a set time window of short-time intervals T1 (e.g., T1<=1 second), the performance analyzer 522 may provide FW parameters set to one or more flash translation layers (FTLs). In response, the one or more flash translation layers and/or the power consumption meter 530 may provide performance characteristics and measured power to the performance analyzer 522. After determination of suboptimal parameters, during a certain period of idle time T2, the performance optimizer 520A may be turned off and the SSD 10 works with the provided FW parameters.

The performance optimizer 520A may introduce small additional computational overhead to the work of the SSD 10 because it can work in parallel with HIO 510 on a separate POU 520. A small delay (<<T1) is possible, related to processing of the performance analyzer 522 for some computing-intensive metrics, such as latencies percentiles. In this case, every new latency value of a host command should be inserted in the ordered arrays of values of read and write commands for log N_i operations, where N_i is the number of already existing values in the read (i=1) or write (i=2) arrays, N=max{N_1+N_2}=IOPS*T1 is a number of processed host commands per T1. However, it's not critical for the proposed suboptimal FW parameters search. A maximal time of convergence to a new suboptimal parameter set is M*T1, where M is a number of search algorithm steps (depends on workload), and on every step, a new FW parameter set is selected and checked.

In accordance with the scheme A above, workload should be stable for long enough time (greater than time M*T1 of optimization process), i.e., workload characteristics are almost constants. During the search, the SSD 10 is in the transient mode. When suboptimal parameters are found, the SSD 10 will be in a steady state.

A scheme B of firmware (FW) parameters tuning is described with reference to FIGS. 9 to 12.

FIG. 9 is a diagram illustrating a solid state drive (SSD) 10 in accordance with an embodiment of the present invention.

Referring to FIG. 9, the SSD 10 may include components such as the controller 100, the memory device (e.g., a NAND flash memory device) 200, a power consumption meter or estimator (PCM/E) (hereinafter referred to as a power consumption meter) 530 and a dynamic random access memory (DRAM) 540, as shown in FIG. 5. That is, the controller 100 may include a control component 120, a host input and output (HIO) component 510 and a performance optimizer unit (POU) 520. The control component 120 may include a plurality of flash translation layers (FTLs) and a plurality of FTL flash central processor units (FCPUs) (e.g., m FTLs and m FCPUs). The HIO component 510 may include elements 510A such as a command dispatcher (CD) and a host responder (HR). Thus, descriptions for the same components are omitted.

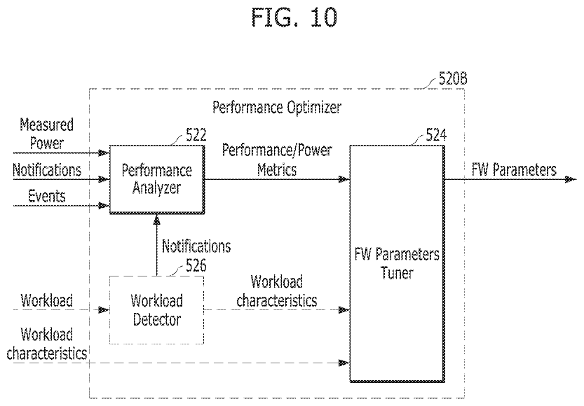

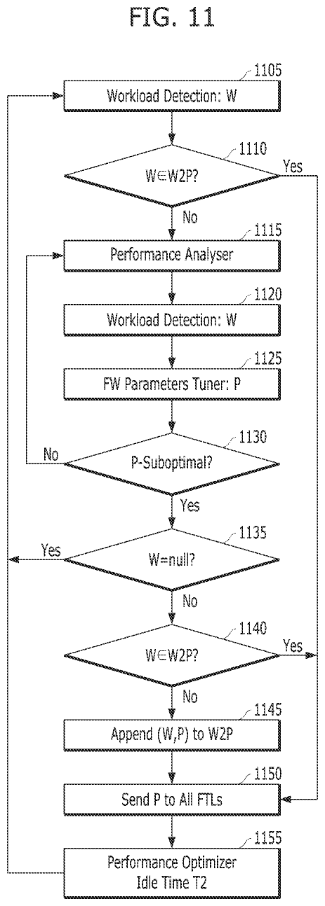

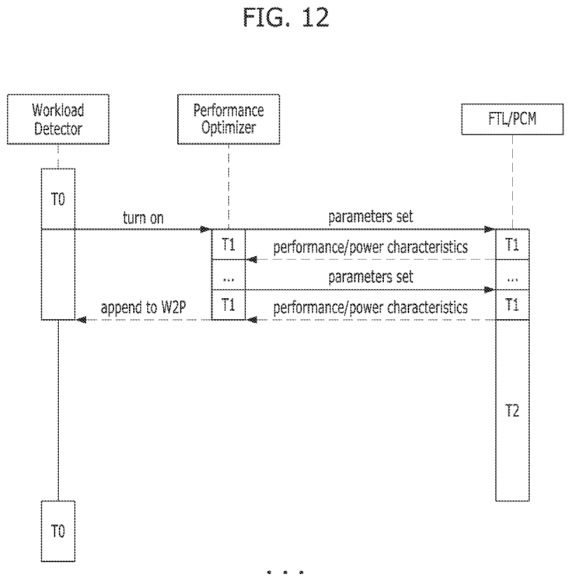

In the illustrated embodiment in FIG. 9, the performance optimizer unit (POU) 520 may include a performance optimizer 520B. The performance optimizer 520B may include a performance analyzer 522, a firmware (FW) parameters tuner 524 and a workload detector 526, as shown in FIG. 10. The performance analyzer 522 and the FW parameters tuner 524 work as described with reference to FIG. 5. The performance optimizer 520B may perform a firmware parameter tuning scheme, in accordance with a flow as shown in FIG. 11 and a sequence as shown in FIG. 12. Thus, descriptions for the same components are omitted.

The workload detector 526 may measure workload characteristics from the host 5. As illustrated, the workload detector 526 may be implemented as a part of the SSD 10 (i.e., FW or HW module). In other embodiments, the workload detector 526 may be located on the host side and notify the controller 100 with workload characteristics, e.g., by namespace type via NVMe protocol.

In some embodiments, workloads may be characterized by vectors W=(w_1, . . . , w_r) of workload characteristics with elements, such as host queue depth (QD), read/write ratio (RWR), sequential/random ratio (SRR), command block size (CBS), etc. The predefined correspondence plane table “workload characteristics—suboptimal parameters” (W2P table) may be written as a part of the flash translation layer (FTL) FW code and be uploaded into DRAM 540.

The workload detector 526 may detect the current workload characteristics during some given time window T0>>T1 (it may return null if the workload is not stable on the measured interval) (1105 of FIG. 11, FIG. 12). Then workload characteristics may be compared with the already measured ones in the W2P table (1110). For the current workload, if suboptimal parameters were already found and contained in the W2P table (1110, Yes), then they are applied in FTL FW (1150) and parameters optimization is not carried out.

If the workload detector 526 finds a new set of workload characteristics which is not contained in the W2P table (or at least one of the workload characteristics differs from the saved ones in the W2P table on a given threshold) (1110, No), then the workload detector 526 sends a notification to the performance analyzer 522 and the performance analyzer 522 is turned on (1115). The performance analyzer 522 may receive host commands delays from CD/HR 510A, measured or estimated power consumption from PCM/E 530, and events statistics from FTLs and store statistics on the host command latencies, IOPS, power consumption, and internal events during a window period T1. Then the performance analyzer 522 may compute the needed performance/power metrics on this window period.

After that, the FW parameters tuner 524 may implement a selection of FW parameters set using the received values of the performance/power metrics and may send the changed FW parameters set to all existing FTLs (1125). The cycle of FW parameters change based on the performance/power metrics may be repeated several times until the suboptimal FW parameters set is found (1130, Yes) in accordance with a search algorithm in the FW parameters tuner 524. In some embodiments as mentioned above, one implementation of suboptimal search algorithm is described in U.S. patent application Ser. No. 17/063,349, entitled “FIRMWARE PARAMETERS OPTIMIZING SYSTEMS AND METHODS” which is incorporated by reference herein in its entirety. At the moment of turning on the performance analyzer 522, the workload detector 526 may start measuring workload characteristics again and continue measuring up to the finish of the search algorithm work (1120).

If workload characteristics W measured during the search algorithm running are stable (i.e., output of the workload detector 526 is not null) (1135, No) and the workload characteristics are not contained in the W2P table (1140, No), then the FW parameters tuner 524 creates a new record in the W2P table (1145) and sends the found suboptimal parameters to the FTLs (1150). Otherwise, the record in the W2P table is skipped. After that, the performance optimizer 520B may be turned off and the SSD 10 works with new parameters during time interval T2 (1155 of FIG. 11, FIG. 12). Then the workload detector 526 may measure workload characteristics once again and the process described above is repeated. The initial parameters set for the FW parameters tuner 524 may be selected from the W2P table according to the principle that a new workload should be the nearest one to the selected workload in some metric. In some embodiments, the W2P table may be extended and updated by means of a vendor unique command.

In some embodiments of scheme B, the performance analyzer 522 and the workload detector 524 may work in parallel. The time of convergence to a new suboptimal parameter set is M*T1 as in Scheme A for a new workload and almost instantaneous for the already known workload from the W2P table.

An example of embodiments is described below.

As an example of the proposed schemes, consider the implementation of optimization of suspension of low-priority operations (LPO), such as program and erase operations. The suspension is one of the important algorithms for improving read access latency. Program suspension may be controlled in firmware (FW) by several parameters. One of the parameters may characterize the minimal duration of program partition before program operation may be suspended and this parameter is defined by p_1. The analogical suspension scheme may be implemented for the erase operation. The parameter of the minimal duration of erase partition before the erase operation may be suspended is defined by p_2. Parameters p_1, p_2 may be measured in time units (e.g., microseconds) and may change in some ranges. FW also may control the maximum numbers of host read commands that can be served per one suspend, which are defined as p_3 for the program suspend and p_4 for the erase suspend. In order to improve read latency, parameters p_1, p_2 should be decreased and parameters p_3, p_4 should be increased, but on the other hand, these changes also may affect write latency in the opposite way.

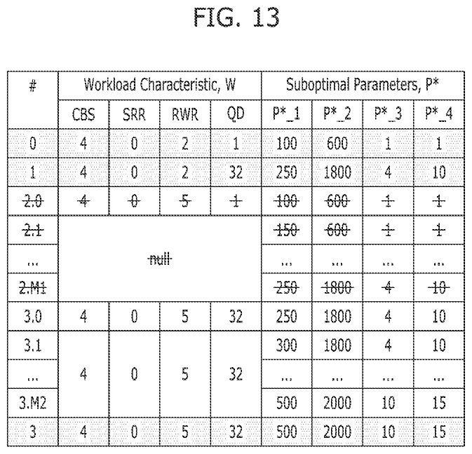

It is considered that firmware (FW) parameters auto-tuning implementation in accordance with the scheme B. FIG. 13 shows the process of filling (or building) the W2P table on hypothetical workloads.

In FIG. 13, CBS represents a block size of a command (command block size), SRR represents a sequential/random ratio (i.e., a ratio of sequential to random commands (or workloads) or data for a memory system), RWR represents a read/write ratio (i.e., a ratio of read to write commands or data for a memory system) and QD represents a host queue depth. It is supposed that T0=1 hour, T1=1 second, T2=0, and the original (predefined) W2P table consists of 2 rows: #0 and #1 as shown in FIG. 13.

Initial workload characteristics and FW parameters set are presented in row #0.

During the period of time T0, the workload detector 526 finds that workload characteristics change, e.g., QD becomes equal to 32. The workload detector 526 searches the same workload characteristics in the W2P table. Since it is present there (row #1), the FW parameters tuner 524 sends the corresponding parameters set to all FTLs.

During the next period of time T0, the workload detector 526 finds that workload characteristics change again, e.g., RWR becomes equal to 5 (row #2.0). Since the corresponding record is absent in the original W2P table, the workload detector 526 sends a notification to the performance analyzer 522 to start measurements. In the next M1 seconds (where M1 is a number of search algorithm steps), the FW parameters tuner 524 receives the calculated performance/power metrics on every 1 second intervals and according to the search algorithm, makes a decision on how to change FW parameters (rows #2.1-#2.M1). During the time interval of M1 seconds, the workload detector 526 continues computing workload characteristics. If the workload had changed its characteristics before the suboptimal parameters have been found, the workload detector 526 returns null. In this case, as shown in FIG. 13, a new record in W2P is not made.

During the next period of time 70, the workload detector 526 finds that workload characteristics have changed again, e.g., QD becomes equal to 32 (row #3.0). Since the corresponding record is absent in the W2P table, the workload detector 526 sends a notification to the performance analyzer 522 to start measurements. In the next M2 seconds (where M2 is a number of the search algorithm steps for the current workload), the FW parameters tuner 524 receives the calculated performance/power metrics on every 1 second intervals and according to the search algorithm, makes a decision on how to change FW parameters (rows #3.1-#3.M2). The initial parameters set is selected from the W2P table as a set for a vector of workload characteristics nearest to the newly detected one in some metric, e.g., the sum of absolute values of differences between the elements of workload vectors. In the example, it is #1. In the same time interval (i.e., M2 seconds), the workload detector 526 continues computing workload characteristics and returns the same vector of workload characteristics as row #3.0. In this case, as shown in FIG. 13, a new record (#3) in the W2P table is made.

As described above, embodiments provide schemes to automatically tune or adjust FW parameters for performance and power consumption enhancement of a memory system (e.g., SSD) based on the measurement of performance metrics and power consumption in real time and adjustment parameters to changing workloads by a feedback loop on the fly. Embodiments may improve customers' performance metrics of SSD under restrictions on power consumption.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives that fall within the scope of the appended claims.

What is claimed is:

1. A data processing system comprising:
a host; and
a memory system coupled to the host, and the memory system including a memory device and a controller for controlling the memory device,
wherein the controller includes firmware and a performance optimizer configured to:
compute one or more performance and power metrics based on commands received from the host;
select a parameter set among multiple parameter sets for the firmware based on the one or more performance and power metrics; and
provide the selected parameter set to use in one or more flash translation layers.

2. The data processing system of claim 1, wherein the performance optimizer is configured to:
receive notifications about the commands and events associated with executions of the commands, which are associated with the workload characteristics, and power consumption of the memory system; and
compute the one or more performance and power metrics based on the received notifications, events and power consumption.

3. The data processing system of claim 2, wherein the notifications include a type, an arrival time and a response time for each command.

4. The data processing system of claim 2, wherein the events are received by the one or more flash translation layers.

5. The data processing system of claim 2, wherein the one or more performance metrics are associated with one or more of throughput, latency and consistency or their combination as weighted sum.

6. The data processing system of claim 2, wherein the power consumption is measured by a power meter within the memory system.

7. The data processing system of claim 2, wherein the power metrics include an average power consumption and maximal power consumption.

8. The data processing system of claim 2, wherein the performance optimizer performs the operations of computing, selecting and providing firmware parameters sets in a first time interval.

9. The data processing system of claim 8, wherein the performance optimizer is turned off in a second time interval after the first time interval, and the memory system works with the selected parameter set in the second time interval longer than the first time interval.

10. A data processing system comprising:
a host; and
a memory system coupled to the host, and the memory system including a memory device and a controller for controlling the memory device,
wherein the controller includes:
firmware;
a workload detector configured to measure workload characteristics associated with commands received from the host; and
a performance optimizer configured to:
compute one or more performance and power metrics based on the measuring of the workload characteristics;
select a parameter set among multiple parameter sets for the firmware based on the one or more performance and power metrics; and
provide the selected parameter set to use in one or more flash translation layers.

11. The data processing system of claim 10, wherein the controller further includes a table storing multiple workload characteristics and multiple parameter sets for the firmware, and
wherein the performance optimizer is configured to be turned on to compute the one or more performance and power metrics when it is detected that the measured workload characteristics do not exist in the table.

12. The data processing system of claim 11, wherein the performance optimizer is configured to:
receive notifications about the commands and events associated with executions of the commands, which are associated with the workload characteristics, and power consumption of the memory system; and
compute the one or more performance and power metrics based on the received notifications, events and power consumption.

13. The data processing system of claim 12, wherein the notifications include a type, an arrival time and a response time for each command.

14. The data processing system of claim 12, wherein the events such as changes in firmware counters are received from the one or more flash translation layers.

15. The data processing system of claim 12, wherein the one or more performance metrics are associated with one or more of throughput, latency and consistency or their combination as weighted sum.

16. The data processing system of claim 12, wherein the power consumption is measured by a power meter within the memory system.

17. The data processing system of claim 12, wherein the power metrics include an average power consumption and maximal power consumption.

18. The data processing system of claim 12, wherein the performance optimizer performs the operations of computing, selecting and providing in a first time interval.

19. The data processing system of claim 18, wherein the performance optimizer is turned off in a second time interval after the first time interval, and the memory system works with the selected parameter set in the second time interval longer than the first time interval.

20. The data processing system of claim 12, wherein the workload characteristics include a combination of a queue depth of the host, a ratio of read to write of data for the memory system, a ratio of sequential data to random data for the memory system, and a block size of a command for the memory system.
